(19) United States
(12) Patent Application Publication
(10) Pub. No.: US 2026/0080229 A1
(43) Pub. Date: Mar. 19, 2026

(54) ACTIVATION FUNCTION COMPUTING DEVICE AND COMPUTING METHOD THEREOF

(71) Applicant: NEUCHIPS CORPORATION, Hsinchu City (TW)

(72) Inventors: Shen-Jui Huang, Hsinchu County (TW); Yuan Lung Lo, Hsinchu County (TW)

(73) Assignee: NEUCHIPS CORPORATION, Hsinchu City (TW)

(21) Appl. No.: 19/045,531

(22) Filed: Feb. 4, 2025

(30) Foreign Application Priority Data
Sep. 19, 2024 (TW) 113135467

(51) Int. Cl. G06N 3/048; G06N 3/063

(52) U.S. Cl. CPC G06N 3/048; G06N 3/063

(57) ABSTRACT

An activation function computing device and a computing method thereof are provided. The activation function computing device computes an input value conforming to a floating-point number format to generate an output value. The activation function computing device includes a plurality of lookup tables and a controller. The plurality of lookup tables respectively store correspondences between a plurality of mantissa values and a plurality of coefficients. The controller selects a selected coefficient from the coefficients according to an input exponent part and an input mantissa part of the input value. The controller computes the selected coefficient and the input value according to an approximation function including a Sigmoid function to generate the output value which conforms to the floating-point number format and has high accuracy.

### CROSS-REFERENCE TO RELATED APPLICATION

This application claims the priority benefit of Taiwan application serial no. 113135467, filed on Sep. 19, 2024. The entirety of the above-mentioned patent application is hereby incorporated by reference herein and made a part of this specification.

### BACKGROUND

### Technical Field

The invention relates to a computing device and a computing method adapted to the computing device, and particularly relates to an activation function computing device for computing an input value conforming to a floating-point number format and a computing method thereof.

### Description of Related Art

Self-attention model (Transformer) has been widely used in large language model (LLM) to implement various natural language processing (NLP) applications, such as ChatGPT, Llama etc. Generally, the self-attention model requires the use of a plurality of functions such as matrix computation, vector computation, nonlinear computation, etc. The nonlinear computation includes, for example, a Gaussian error linear unit (Gelu) function, a Softmax function, and a Layer Norm function.

However, due to a complex equation of the Gelu function, the computation of the Gelu function is quite time-consuming, and an output accuracy of the Gelu function is not high. In some ways, the equation of the Gelu function may be implemented through application specific integrated circuits (ASICs). However, the current ASICs require a large amount of hardware area to implement the Gelu function, and cannot improve the output accuracy of the Gelu function.

### SUMMARY

The invention is directed to an activation function computing device, which is adapted to efficiently compute a Gelu function and achieve high-precision output values.

An embodiment of the invention provides an activation function computing device adapted to compute an input value conforming to a floating-point number format to generate an output value. The activation function computing device includes a plurality of lookup tables and a controller. The lookup tables respectively store correspondences between a plurality of mantissa values and a plurality of coefficients. The controller is configured to select a selected coefficient from the coefficients according to an input exponent part and an input mantissa part of the input value. The controller computes the selected coefficient and the input value according to an approximation function including a Sigmoid function to generate the output value conforming to the floating-point number format.

An embodiment of the invention provides a computing method of an activation function computing device. The activation function computing device is configured to compute an input value conforming to a floating-point number format to generate an output value. The computing method includes following steps. Correspondences between a plurality of mantissa values and a plurality of coefficients are respectively stored in a plurality of lookup tables. A selected coefficient is selected from the coefficients by a controller according to an input exponent part and an input mantissa part of the input value. The selected coefficient and the input value are computed by the controller according to an approximation function including a Sigmoid function to generate the output value conforming to the floating-point number format.

Based on the above description, the activation function computing device and the computing method thereof according to the embodiments of the invention store the correspondences between the plurality of mantissa values and the plurality of coefficients through the lookup tables, and the controller may obtain the selected coefficient corresponding to the input value based on the lookup tables. By using the controller to compute the selected coefficient and the input value based on the approximation function related to the Gelu function, the activation function computing device may reduce energy consumption in a computing process, and may adaptively compute the input value and the corresponding selected coefficient thereof, thereby improving the accuracy of the output value.

To make the aforementioned more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a circuit block diagram of an activation function computing device according to an embodiment of the invention.

FIG. 2 is a flowchart of a computing method of an activation function computing device according to an embodiment of the invention.

FIG. 3 is a schematic operation diagram of an activation function computing device according to an embodiment of the invention.

FIG. 4 is a flowchart of a computing method of the activation function computing device shown in the embodiment of FIG. 3.

FIG. 5A to FIG. 5B are schematic operation diagrams of the activation function computing device according to the embodiment of FIG. 3.

### DESCRIPTION OF THE EMBODIMENTS

Some embodiments of the invention will be described in detail with reference to the accompanying drawings. The component symbols cited in the following description will be regarded as the same or similar components when the same component symbols appear in different drawings. These embodiments are only part of the invention and do not disclose all possible implementations of the invention. Rather, these embodiments are only examples within the scope of the patent application of the invention.

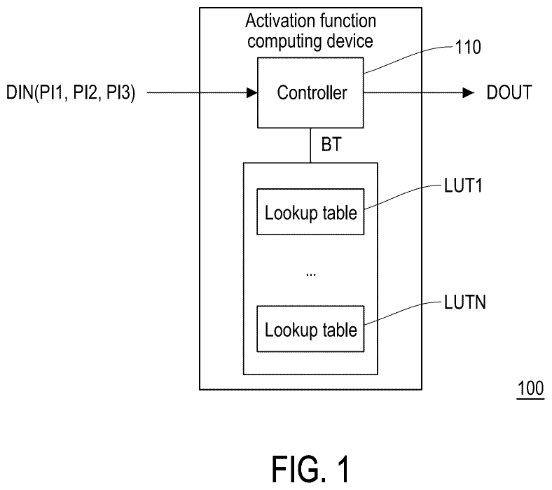

FIG. 1 is a circuit block diagram of an activation function computing device according to an embodiment of the invention. Referring to FIG. 1, an activation function computing device 100 may be applied in a self-attention model (Transformer) to implement applications of various natural language processing (NLP). The activation function computing device 100 is configured to implement a nonlinear computing function. For example, the activation function computing device 100 may implement a computing function of a Gaussian error linear unit (Gelu) function.

In the embodiment, the activation function computing device 100 is configured to receive an input value DIN from a first device. The activation function computing device 100 is configured to compute the input value DIN to generate an output value DOUT, and output the output value DOUT to a second device. The first device is, for example, an encoder used in the self-attention model or an electronic device including a neural network. The second device is, for example, a decoder used in the self-attention model or an electronic device including another neural network. In this way, the second device is configured to perform application operations such as language recognition and/or image recognition, etc., according to the output value DOUT, thereby executing a corresponding artificial intelligence application program.

In the embodiment, the input value DIN conforms to a floating-point number format. Based on the floating-point number format, the input value DIN includes an input sign part PI1, an input exponent part PI2 and an input mantissa part PI3. The floating-point number format is in compliance with the IEEE-754 standard format, and includes, for example, 16-bit, 32-bit, and 64-bit floating-point number formats.

In the embodiment, the activation function computing device 100 includes a controller 110 and a plurality of lookup tables LUT1 to LUTN, where N is a positive integer greater than 1. The controller 110 is configured to access these lookup tables LUT1 to LUTN.

In the embodiment, the controller 110 is, for example, a micro control unit (MCU), a signal converter, a field programmable gate array (FPGA), a central processing unit (CPU), or other programmable general-purpose or special-purpose microprocessor, digital signal processor (DSP), programmable controller, application specific integrated circuits (ASIC), programmable logic device (PLD) or other similar devices or a combination of these devices, which may load and execute relevant firmware or software to implement various computing functions.

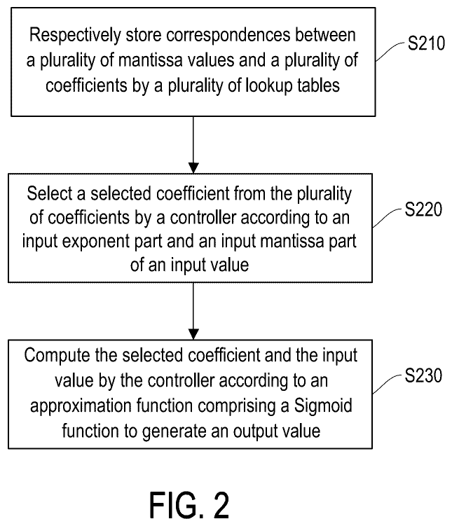

FIG. 2 is a flowchart of a computing method of an activation function computing device according to an embodiment of the invention. Referring to FIG. 1 and FIG. 2, the activation function computing device 100 executes steps S210 to S230. An order of these steps S210 to S230 is only an example, which is not limited by the invention.

In step S210, the plurality of lookup tables LUT1 to LUTN respectively store correspondences between a plurality of mantissa values and a plurality of coefficients. Namely, each of the lookup tables LUT1 to LUTN indicates a different mantissa value corresponding to the respective coefficient.

In the embodiment, the mantissa values in each of the lookup tables LUT1 to LUTN are different values corresponding to various mantissa parts. Taking the 16-bit floating-point number format (i.e., FP16) as an example, the mantissa part corresponding to a plurality of mantissa values is 10 bits, and includes a plurality of values from 0 to 1023. In the embodiment, the coefficient in each of the lookup tables LUT1 to LUTN is an independent variable in an approximation function.

In step S220, the controller 110 selects a selected coefficient BT from a plurality of coefficients according to the input exponent part PI2 and the input mantissa part PI3 of the input value DIN. The selected coefficient BT is a coefficient indicated by one of the plurality of lookup tables LUT1 to LUTN, and is a coefficient corresponding to the input mantissa part PI3.

In step S230, the controller 110 computes the selected coefficient BT and the input value DIN according to an approximation function including a Sigmoid function to generate the output value DOUT. Namely, the controller 110 substitutes the selected coefficient BT and the input value DIN into the approximation function to generate the output value DOUT. The output value DOUT conforms to the floating-point number format.

In the embodiment, the approximation function including the Sigmoid function is used to implement the computing function of the Gelu function. In the embodiment, the approximation function is a function that approximates the Gelu function.

It should be noted that based on the correspondence indicated by each lookup table LUT1 to LUTN, the controller 110 may obtain the selected coefficient BT corresponding to the input mantissa part PI3. By using the controller 110 to compute the selected coefficient BT and the input value DIN according to the approximation function including the Sigmoid function, the activation function computing device 100 may implement the computing function of the Gelu function in an approximation computing manner to generate the output value DOUT, and accordingly provide the output value DOUT to other application devices (for example, a decoder) to continue the operations of applying NLP. In this way, the activation function computing device 100 may reduce time and energy consumption in the computing process. In addition, the activation function computing device 100 may adaptively obtain the selected coefficient BT corresponding to the input value DIN for computing, thereby improving the accuracy of the output value DOUT.

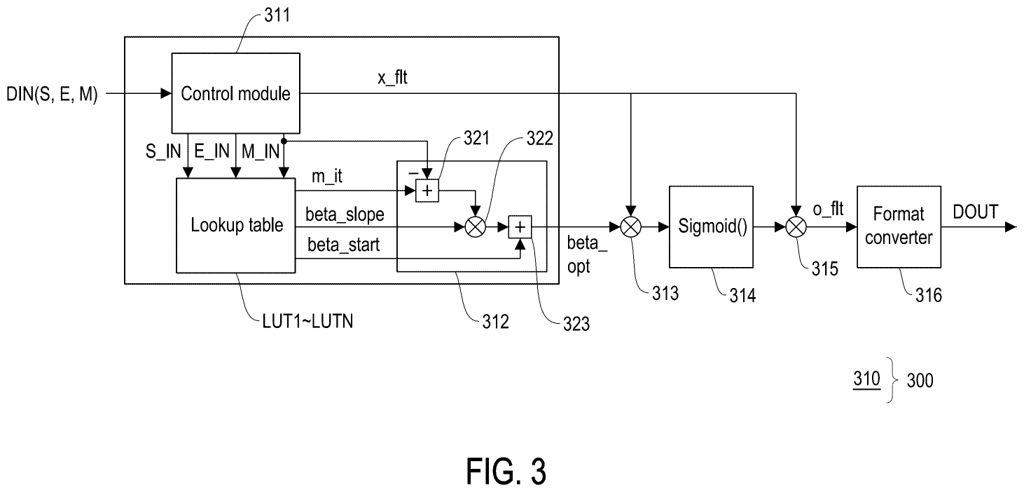

FIG. 3 is a schematic operation diagram of an activation function computing device according to an embodiment of the invention. Referring to FIG. 3, an activation function computing device 300 includes a controller 310 and a plurality of lookup tables LUT1 to LUTN, where N is a positive integer greater than 1. For the controller 310 and the plurality of lookup tables LUT1 to LUTN, reference may be made to the relevant description of the activation function computing device 100 for analogy.

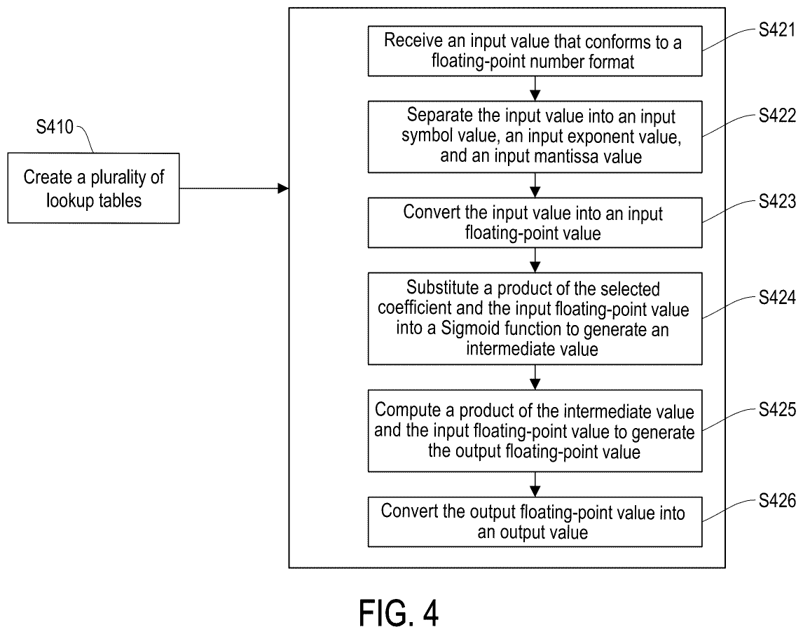

In the embodiment of FIG. 3, the controller 310 includes a plurality of modules 311-316 and 321-323. These modules 311-316 and 321-323 are, for example, implemented in firmware or software, for example, and have various functions. Implementations of these modules 311-316 and 321-323 may be described with reference to the embodiment of FIG. 4 below.

FIG. 4 is a flowchart of a computing method of the activation function computing device shown in the embodiment of FIG. 3. Referring to FIG. 3 and FIG. 4, the activation function computing device 300 executes steps S410 and S421-S426. An order of these steps S410 and S421-S426 is only an example, and the invention is not limited thereto.

In step S410, the controller 310 creates a plurality of lookup tables LUT1 to LUTN. In the embodiment, these lookup tables LUT1 to LUTN respectively correspond to a plurality of different exponent values. Taking FP16 as an example, the exponent part corresponding to the plurality of exponent values is 5 bits and includes a plurality of values from 0 to 30. Namely, the plurality of lookup tables LUT1 to LUTN respectively correspond to a plurality of different exponent values from 0 to 30.

In detail, the controller 310 computes a plurality of reference input values according to the Gelu function to generate a plurality of reference output values. These reference input values and these reference output values respectively conform to the floating-point number format and are represented by floating-point values. Namely, each reference input value includes a reference symbol value, a reference exponent value, and a reference mantissa value. The controller 310 substitutes each reference input value into the Gelu function to generate the corresponding reference output value.

In the embodiment, the Gelu function is expressed by a following equation (1). g( ) in the equation (1) is an output value of the Gelu function (for example, the reference output value), and x is an input value of the Gelu function (for example, the reference input value).

$$g ( x ) = 0.5 x ( 1 + tan h ( \sqrt{\frac{2}{π}} ( x + 0.044715 {x}^{3} ) ) ) \qquad equation ( 1 )$$

Then, the controller 310 obtains a plurality of distribution graphs based on correspondences between a plurality of reference mantissa values of each of the reference input values and the plurality of reference output values. In each distribution graph, the correspondence between the plurality of reference mantissa values and the plurality of reference output values includes, for example, a single line segment that is approximately a straight line, or a plurality of continuous line segments that are approximately a straight line.

Taking FP16 as an example, under the condition of having a certain reference exponent value (i.e., one of 0 to 30), the mantissa part corresponding to the reference mantissa values of each reference input value is 10 bits, and includes a plurality of values from 0 to 1023. In this way, based on different reference exponent values, the controller 310 obtains 0 to 30 distribution graphs to respectively indicate the correspondences between different reference mantissa values (i.e., a plurality of values from 0 to 1023) and the corresponding plurality of reference output values.

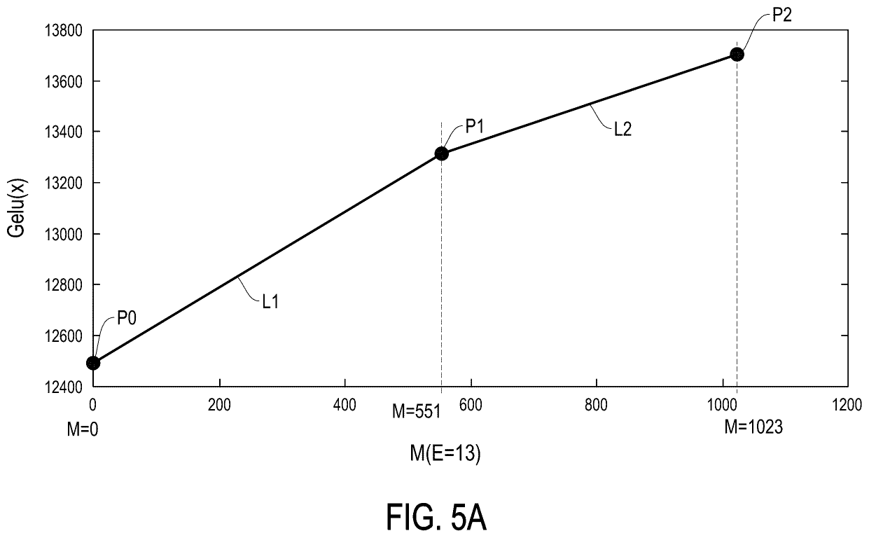

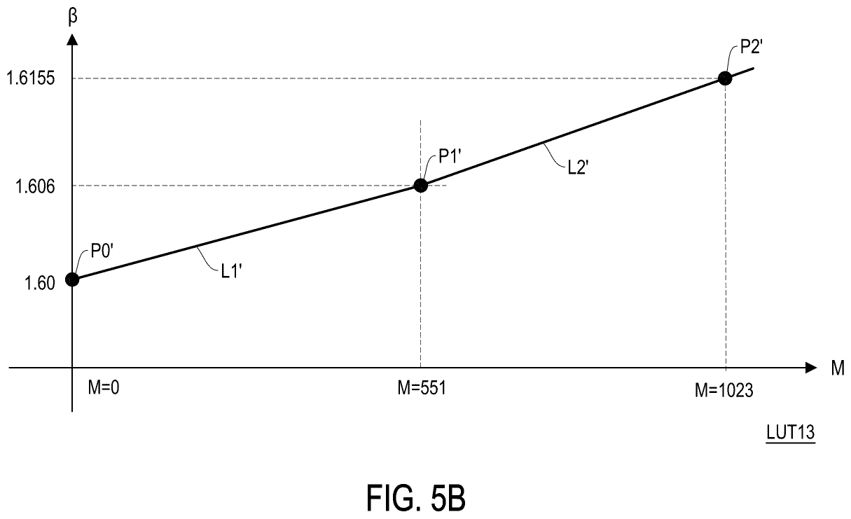

Referring to FIG. 5A to FIG. 5B, FIG. 5A to FIG. 5B are schematic operation diagrams of the activation function computing device according to the embodiment of FIG. 3, which illustrate how the controller 310 creates a lookup table (for example, the lookup table LUT13) corresponding to a certain exponent value (for example, 13). For the lookup tables LUT1 to LUTN corresponding to other exponent values, reference may be made to the relevant descriptions in FIG. 5A and FIG. 5B for analogy.

In FIG. 5A, a horizontal axis represents the reference mantissa values, which are represented by M. A vertical axis represents the output values of the Gelu function, i.e., the reference output values, which are represented by FP16. Taking a plurality of reference input values having the reference symbol value equal to 0 and the reference exponent value equal to 13 (i.e., “E=13” as shown in FIG. 5A) as an example, the controller 310 analyzes correspondences between the plurality of reference mantissa values (i.e., M) of the reference input values and the corresponding plurality of reference output values (i.e., Gelu(x)) to generate a distribution graph shown in FIG. 5A.

As shown in FIG. 5A, in an interval from the reference mantissa value equal to 0 to the reference mantissa value equal to 551 (i.e., M=0 to M=551), the plurality of reference output values form a straight line segment L1 with a first slope, or the line segment L1 that is approximately a straight line. In an interval from the reference mantissa value equal to 551 to the reference mantissa value equal to 1023 (i.e., M=551 to M=1023), the plurality of reference output values form another straight line segment L2 with a second slope, or another line segment L2 that is approximately a straight line. In this way, the controller 310 obtains a plurality of intercept points (or turning points) P0, P1 and P2 based on these line segments L1 and L2.

Then, the controller 310 computes a coefficient corresponding to at least one of the plurality of reference mantissa values of each distribution graph according to the approximation function. The aforementioned computed reference mantissa values include mantissa values corresponding to the intercept points in each distribution graph. For example, in FIG. 5A, the reference mantissa values include reference mantissa values (i.e., M=0, M=551, and M=1023) respectively corresponding to the plurality of intercept points P0, P1, and P2.

In the embodiment, the approximation function is represented by a following equation (2). g′(x) in the equation (2) is an output value of the approximation function (i.e., an approximation value of an output value of the Gelu function), x is an input value of the approximation function (for example, the reference input value), β is a coefficient, and σ( ) is the Sigmoid function.

$${g}^{′} ( x ) = x σ ( β x ) \qquad equation ( 2 )$$

It should be noted that β in the equation (2) may be used as an independent variable of the approximation function rather than a fixed value, and may change according to the input value of the approximation function. In this way, a product of the coefficient (i.e., β) and the input value may generate an accurate approximate result of the Gelu function based on the Sigmoid function.

Taking the distribution graph shown in FIG. 5A as an example, the controller 310 obtains the reference mantissa value corresponding to the intercept point P0 (i.e., M=0) and the reference output value (i.e., the output value of the Gelu function corresponding to M=0). The controller 310 uses the aforementioned reference output value as the output value of the approximation function, and uses the reference input value corresponding to the intercept point P0 as the input value of the approximation function to compute the reference output value and the reference input value according to equation (2) to generate the corresponding coefficient (i.e., β=1.6). The aforementioned reference input value is, for example, an input value having the reference symbol value equal to 0, the reference exponent value equal to 13, and the reference mantissa value equal to 0, and is represented by FP16.

Similarly, the controller 310 uses the reference output value corresponding to the intercept point P1 (i.e., the output value of the Gelu function corresponding to M=551) as the output value of the approximation function, and uses the reference input value corresponding to the intercept point P1 as the input value of the approximation function to produce the corresponding coefficient (i.e., β=1.606) according to the equation (2). The aforementioned reference input value is, for example, an input value having the reference symbol value equal to 0, the reference exponent value equal to 13, and the reference mantissa value equal to 551, and is represented by FP16. Similarly, the controller 310 further generates the corresponding coefficient (i.e., β=1.6155) based on the intercept point P2 and the equation (2).

In the embodiment, the controller 310 may repeatedly perform the above-described operations with respect to the equation (1) based on the reference input values having different exponent values to obtain a plurality of distribution graphs corresponding to a plurality of exponent values from 0 to 30. The controller 310 obtains one or a plurality of straight line segments and two endpoints (i.e., intercept points) of the straight line segment in each distribution graph. In addition, the controller 310 further repeatedly performs the above-mentioned operations with respect to the equation (2) based on different distribution graphs to obtain the correspondence between the reference mantissa value and the coefficient of one or a plurality of intercept points in each distribution graph.

Namely, the controller 310 obtains a plurality of distribution graphs having accurate output values of the Gelu function based on the Gelu function, and obtains one or a plurality of intercept points from each distribution graph (for example, the intercept point P0 to P2 included in FIG. 5A). For each distribution graph, the controller 310 computes the reference input value and the reference output value corresponding to the intercept point(s) based on the approximation function to generate the corresponding coefficient. In addition, the controller 310 creates a single lookup table (for example, the lookup table LUT13 with the exponent value equal to 13) based on the reference mantissa values (for example, including M=0, M=551, and M=1023) and the coefficients (for example, including β=1.6, β=1.606, and β=1.6155) corresponding to the intercept point(s).

It should be noted that the controller 310 creates each of the lookup tables LUT1 to LUTN based on a plurality of reference mantissa values of a plurality of reference input values and corresponding coefficients. These reference input values have the same exponent value (for example, E=13). In this way, each of the lookup tables LUT1 to LUTN respectively correspond to the respective exponent values.

In the details of step S410, the controller 310 obtains a first intercept point and a second intercept point of at least one line segment from each distribution graph. The line segment is, for example, a straight line segment or a line segment that is approximately a straight line. The different intercept points are, for example, two endpoints of this line segment. In addition, the controller 310 computes the first intercept point and the second intercept point according to the approximation function to generate a first coefficient and a second coefficient respectively.

Then, the controller 310 obtains coefficient slope values according to the plurality of reference mantissa values corresponding to the above-mentioned first coefficient, the second coefficient and the first intercept point and the second intercept point. The coefficient slope values indicate slope values of line segments formed by these coefficients and the corresponding plurality of reference mantissa values. The controller 310 records the plurality of reference mantissa values and the coefficient slope values corresponding to the first intercept point and the second intercept point to create each of the lookup tables LUT1 to LUTN.

Taking the distribution graph shown in FIG. 5A as an example, the controller 310 obtains the plurality of intercept points P0 and P1 of the line segment L1. The controller 310 generates a coefficient (i.e., β=1.6) corresponding to the intercept point P0 according to the approximation function shown in the above equation (2), and generates a coefficient (i.e., β=1.606) corresponding to the intercept point P1.

Then, as shown in FIG. 5B, the controller 310 uses the coefficient (i.e., $=1.6) and the reference mantissa value (i.e., M=0) corresponding to the intercept point P0 in the line segment L1 shown in FIG. 5A as a first endpoint P0′, and uses the coefficient (i.e., β=1.606) and the reference mantissa value (i.e., M=551) corresponding to the other intercept point P1 in the line segment L1 as a second endpoint P1′.

In FIG. 5B, the horizontal axis represents the reference mantissa values, which are represented by M. The vertical axis represents the coefficients (i.e., β) of the approximation function. The first endpoint P0′ has a reference mantissa value (i.e., M=0) and a coefficient (i.e., β=1.6). The second endpoint P1′ has a reference mantissa value (i.e., M=551) and a coefficient (i.e., β=1.606). The first endpoint P0′ and the second endpoint P1′ form a straight line segment L1′, or a line segment L1′ that is approximately a straight line. The controller 310 computes a slope of this line segment L1′ as a coefficient slope value.

Continuing the above description, the controller 310 records the plurality of reference mantissa values (i.e., M=0 and M=551) corresponding to the two endpoints P0′ and P1′ on the line segment L1′ and the slope value of the line segment L1′. The controller 310 uses the aforementioned recorded information as the content of the lookup table (for example, the lookup table LUT13).

Similarly, in the examples of FIG. 5A and FIG. 5B, the controller 310 further obtains a plurality of intercept points P1 and P2 of the other line segment L2 to further generate the coefficient (i.e., β=1.6155) corresponding to the intercept point P2. The controller 310 converts the plurality of intercept points P1 and P2 in the line segment L2 into a plurality of endpoints P1′ and P2′ represented by coefficients (i.e., B) and reference mantissa values (i.e., M), and accordingly generate a slope value of a line segment L2′ between these endpoints P1′ and P2′. In this way, the lookup table LUT13 further stores recorded information related to the line segment L2′.

Namely, for the input value DIN having the exponent value of 13, based on the lookup table LUT13 indicated in FIG. 5B, the controller may obtain the corresponding coefficient (i.e., B) according to the mantissa value (i.e., any M value) of the input value DIN. The controller 310 substitutes the input value DIN and the obtained coefficient into the approximation function shown in the equation (2) to generate an approximate result of the Gelu function.

Returning to the embodiments of FIG. 3 and FIG. 4, the controller 310 executes steps S421 to S426 to generate a result (i.e., the output value DOUT) of the Gelu function according to the input value DIN.

In step S421, the controller 310 executes the control module 311 to receive the input value DIN that conforms to the floating-point number format by the control module 311. Taking FP16 as an example, the input value DIN includes an input symbol value “S”, an input exponent value “E” and an input mantissa value “M”.

In step S422, the controller 310 executes the control module 311 to separate the input value DIN into an input symbol value S_IN, an input exponent value E_IN and an input mantissa value M_IN by the control module 311.

In step S423, the controller 310 executes the control module 311 to convert the input value DIN into an input floating-point value x_flt by the control module 311. Namely, the controller 310 converts the input value DIN expressed in FP16 into the floating-point value x_flt that may be computed.

In addition, the controller 310 accesses the plurality of lookup tables LUT1 to LUTN, and selects a selected lookup table from these lookup tables LUT1 to LUTN according to the input exponent value E_IN. The controller 310 computes the input mantissa value M_IN according to the selected lookup table to generate a selected coefficient beta_opt (i.e., the selected coefficient BT shown in FIG. 1).

Taking the input exponent value E_IN equal to 13 as an example, the controller 310 selects the selected lookup table LUT13 as indicated in FIG. 5B. The selected lookup table LUT13 records the plurality of reference mantissa values (i.e., M=0 and M=551) and the coefficient slope value (for example, the first slope value) corresponding to the line segment L1′, and further records the plurality of reference mantissa values (i.e., M=551 and M=1023) and the coefficient slope value (for example, a second slope value) corresponding to the other line segment L2′. In this way, the controller 310 learns the line segment L1′ or L2′ where the input mantissa value M_IN is located based on the lookup table LUT13, and accordingly generates the coefficient (i.e., the β value, that is, the selected coefficient beta_opt) corresponding to the input mantissa value M_IN.

Specifically, the controller 310 selects a selected line segment corresponding to the input mantissa value M_IN in the selected lookup table LUT13. The controller 310 computes the selected coefficient beta_opt corresponding to the input mantissa value M_IN according to the slope and the intercept point of the selected line segment.

As shown in FIG. 5B, the controller 310 compares the input mantissa value M_IN with the reference mantissa value corresponding to each of the endpoints P0′ to P2′ (i.e., M=0, M=551 and M1023) to learn which two of the endpoints P0′ to P2′ the input mantissa value M_IN is located between. It is assumed that the input mantissa value M_IN is between 511 and 1023, the controller 310 selects the line segment L2′ formed between the two endpoints P1′ and P2′ as the selected line segment.

Then, the controller 310 learns a slope beta_slope of the line segment L2′ and the intercept points P1′ and/or P2′ based on the selected lookup table LUT13. Since the input mantissa value M_IN is located on this line segment L2′, the controller 310 obtains the coefficient (i.e., the selected coefficient beta_opt) corresponding to the input mantissa value M_IN based on a linear interpolation method.

In the embodiment, the linear interpolation method is expressed by a following equation (3). y in the equation (3) is the selected coefficient beta_opt, x is the input mantissa value M_IN, m is the slope beta_slope (i.e., the second slope value) of the selected line segment (for example, the line segment L2′), y0 is the coefficient beta_start (i.e., β=1.606) corresponding to the intercept point of the selected line segment L2′ (for example, the endpoint P1′), and x0 is a mantissa value m_it corresponding to the intercept point P1′ (i.e., M=551).

$$y - y 0 = m ( x - x 0 ) \qquad equation ( 3 )$$

In detail, based on the equation (3), the controller 310 executes the module 312 to perform an accumulation operation on the input mantissa value M_IN and the mantissa value m_it corresponding to the intercept point P1′ (i.e., M=551) through the module 321 to generate a first value “x−x0” in the equation (3). The controller 310 executes the module 312 to perform a multiplication operation on the aforementioned first value “x−x0” and the slope beta_slope of the selected line segment L2′ through the module 322 to generate a second value “m(x−x0)” in the equation (3). The controller 310 executes the module 312 to perform an accumulation operation on the aforementioned second value “m(x−x0)” and the coefficient beta_start (i.e., β=1.606) corresponding to the intercept point P1′ through the module 323 to generate the selected coefficient beta_opt (i.e., the selected coefficient “y” in the equation (3)).

In some embodiments, each of the lookup tables LUT1 to LUTN is divided into a plurality of sections based on a plurality of mantissa values. Namely, each of the lookup tables LUT1 to LUTN is evenly divided into a plurality of (for example, 16) sections according to the mantissa value. In this case, the controller 310 selects a selected section from the plurality of sections of the selected lookup table LUT13 according to the input mantissa value M_IN to obtain the selected line segment corresponding to the selected section.

Namely, the controller 310 compares the input mantissa value M_IN with the plurality of mantissa values corresponding to each section, so as to learn which section the input mantissa value M_IN is located. The controller 310 takes the section where the input mantissa value M_IN is located as the selected section, and selects the line segment corresponding to the selected section as the selected line segment. Then, the controller 310 computes the selected coefficient beta_opt corresponding to the input mantissa value M_IN according to the slope and the intercept point of the selected line segment, as shown in the above description of the equation (3).

In the embodiment, the controller 310 executes the plurality of modules 312 to 316 to compute the selected coefficient and the input floating-point value x_flt according to the approximation function shown in the above equation (2) through these modules 312 to 316 to generate an output floating-point value o_flt.

In detail, in step S424, the controller 310 substitutes a product of the selected coefficient beta_opt and the input floating-point value x_flt into the Sigmoid function to generate an intermediate value.

Namely, the controller 310 executes the module 313 to perform a multiplication operation on the selected coefficient beta_opt and the input floating-point value x_flt through the module 313 to generate the product thereof (i.e., the selected coefficient “βx” in the equation (2)). The controller 310 executes the module 314 to substitute the product into the Sigmoid function through the module 314 to generate the intermediate value (i.e., the selected coefficient “σ(βx)” in the equation (2)).

In step S425, the controller 310 computes a product of the intermediate value of step S424 and the input floating-point value x_flt to generate the output floating-point value o_flt. Namely, the controller 310 executes the module 315 to perform a multiplication operation on the intermediate value (i.e., the selected coefficient “σ(Bx)” in the equation (2)) and the input floating-point value x_flt through the module 315 to generate a product thereof (i.e., the selected coefficient “xσ(βx)” in the equation (2)).

In step S426, the controller 310 executes a format converter 316 to convert the output floating-point value o_flt into the output value DOUT through the format converter 316. Namely, the controller 310 converts a result of step S426 into a value represented by FP16 to serve as the output value DOUT.

In summary, the activation function computing device and the computing method thereof according to the embodiments of the invention use the approximation function including the Sigmoid function, and search the selected coefficient in the lookup table based on the linear interpolation method according to an actual magnitude of the input value. In this way, the activation function computing device may obtain the optimal coefficient (i.e., the selected coefficient) corresponding to the input value in the approximation function. Since the lookup table is generated based on the simulation result of the Gelu function, the activation function computing device may generate an accurate and approximate output value of the Gelu function based on the selected coefficient and the approximation function. In addition, by using the controller to obtain the output value based on the approximation function, the activation function computing device may avoid complex computations based on the equation (1), thereby reducing time and energy consumption in the computation process.

It will be apparent to those skilled in the art that various modifications and variations can be made to the disclosed embodiments without departing from the scope or spirit of the invention. In view of the foregoing, it is intended that the invention covers modifications and variations provided they fall within the scope of the following claims and their equivalents.

What is claimed is:

1. An activation function computing device, configured to compute an input value conforming to a floating-point number format to generate an output value, the activation function computing device comprising:
a plurality of lookup tables, respectively storing correspondences between a plurality of mantissa values and a plurality of coefficients; and
a controller, configured to select a selected coefficient from the coefficients according to an input exponent part and an input mantissa part of the input value, and computing the selected coefficient and the input value according to an approximation function comprising a Sigmoid function to generate the output value conforming to the floating-point number format.

2. The activation function computing device as claimed in claim 1, wherein the lookup tables respectively correspond to a plurality of different exponent values.

3. The activation function computing device as claimed in claim 1, wherein the approximation function is a function approximate to a Gaussian error linear unit function.

4. The activation function computing device as claimed in claim 1, wherein the controller is configured to:
separate the input value into an input symbol value, an input exponent value and an input mantissa value;
select a selected lookup table from the lookup tables according to the input exponent value; and
compute the input mantissa value according to the selected lookup table to generate the selected coefficient.

5. The activation function computing device as claimed in claim 4, wherein the controller is configured to:
select a selected line segment corresponding to the input mantissa value in the selected lookup table; and
compute the selected coefficient corresponding to the input mantissa value according to a slope and an intercept point of the selected line segment.

6. The activation function computing device as claimed in claim 4, wherein each of the lookup tables is divided into a plurality of sections according to the mantissa values, and the controller is configured to:
select a selected section from the sections of the selected lookup table according to the input mantissa value to obtain a selected line segment corresponding to the selected section; and
compute the selected coefficient corresponding to the input mantissa value according to a slope and an intercept point of the selected line segment.

7. The activation function computing device as claimed in claim 1, wherein the controller is configured to:
convert the input value to an input floating-point value;
compute the selected coefficient and the input floating-point value according to the approximation function to generate an output floating-point value; and
convert the output floating-point value to the output value.

8. The activation function computing device as claimed in claim 7, wherein the controller is configured to:
substitute a product of the selected coefficient and the input floating-point value into the Sigmoid function to generate an intermediate value; and
compute a product of the intermediate value and the input floating-point value to generate the output floating-point value.

9. The activation function computing device as claimed in claim 1, wherein the controller is configured to:
compute a plurality of reference input values conforming to the floating-point number format according to a Gaussian error linear unit function to generate a plurality of reference output values;
obtain a plurality of distribution graphs according to correspondences between a plurality of reference mantissa values of each of the reference input values and the reference output values;
compute a coefficient corresponding to at least one of the reference mantissa values of each of the distribution graphs according to the approximation function; and
create each of the lookup tables according to the reference mantissa values and the corresponding coefficient.

10. The activation function computing device as claimed in claim 9, wherein the controller is configured to:
obtain a first intercept point and a second intercept point of at least one line segment from each of the distribution graphs;
compute the first intercept point and the second intercept point according to the approximation function to respectively generate a first coefficient and a second coefficient;
obtain a coefficient slope value according to the first coefficient, the second coefficient and the plurality of reference mantissa values corresponding to the first intercept point and the second intercept point; and
record the reference mantissa values corresponding to the first intercept point and the second intercept point and the coefficient slope value to create each of the lookup tables.

11. A computing method of an activation function computing device, wherein the activation function computing device is configured to compute an input value conforming to a floating-point number format to generate an output value, and the computing method comprises:
respectively storing correspondences between a plurality of mantissa values and a plurality of coefficients by a plurality of lookup tables;
selecting a selected coefficient from the coefficients by a controller according to an input exponent part and an input mantissa part of the input value; and
computing the selected coefficient and the input value by the controller according to an approximation function comprising a Sigmoid function to generate the output value conforming to the floating-point number format.

12. The computing method of the activation function computing device as claimed in claim 11, wherein the lookup tables respectively correspond to a plurality of different exponent values.

13. The computing method of the activation function computing device as claimed in claim 11, wherein the approximation function is a function approximate to a Gaussian error linear unit function.

14. The computing method of the activation function computing device as claimed in claim 11, wherein the step of selecting the selected coefficient from the coefficients by the controller according to the input exponent part and the input mantissa part of the input value comprises:
separating the input value into an input symbol value, an input exponent value and an input mantissa value by the controller;
selecting a selected lookup table from the lookup tables by the controller according to the input exponent value; and
computing the input mantissa value by the controller according to the selected lookup table to generate the selected coefficient.

15. The computing method of the activation function computing device as claimed in claim 14, wherein the step of computing the input mantissa value by the controller according to the selected lookup table to generate the selected coefficient comprises:
selecting a selected line segment corresponding to the input mantissa value in the selected lookup table by the controller; and
computing the selected coefficient corresponding to the input mantissa value by the controller according to a slope and an intercept point of the selected line segment.

16. The computing method of the activation function computing device as claimed in claim 14, wherein each of the lookup tables is divided into a plurality of sections according to the mantissa values, and the step of computing the input mantissa value by the controller according to the selected lookup table to generate the selected coefficient comprises:
selecting a selected section from the sections of the selected lookup table by the controller according to the input mantissa value to obtain a selected line segment corresponding to the selected section; and
computing the selected coefficient corresponding to the input mantissa value by the controller according to a slope and an intercept point of the selected line segment.

17. The computing method of the activation function computing device as claimed in claim 11, further comprising:
converting the input value to an input floating-point value by the controller,
wherein the step of computing the selected coefficient and the input value by the controller according to the approximation function comprising the Sigmoid function to generate the output value conforming to the floating-point number format comprises:
computing the selected coefficient and the input floating-point value by the controller according to the approximation function to generate an output floating-point value; and
converting the output floating-point value to the output value by the controller.

18. The computing method of the activation function computing device as claimed in claim 17, wherein the step of computing the selected coefficient and the input floating-point value by the controller according to the approximation function to generate the output floating-point value comprises:
substituting a product of the selected coefficient and the input floating-point value into the Sigmoid function by the controller to generate an intermediate value; and
computing a product of the intermediate value and the input floating-point value by the controller to generate the output floating-point value.

19. The computing method of the activation function computing device as claimed in claim 11, further comprising:
computing a plurality of reference input values conforming to the floating-point number format by the controller according to a Gaussian error linear unit function to generate a plurality of reference output values;
obtaining a plurality of distribution graphs by the controller according to correspondences between a plurality of reference mantissa values of each of the reference input values and the reference output values;
computing a coefficient corresponding to at least one of the reference mantissa values of each of the distribution graphs by the controller according to the approximation function; and
creating each of the lookup tables by the controller according to the reference mantissa values and the corresponding coefficient.

20. The computing method of the activation function computing device as claimed in claim 19, wherein the step of computing the coefficient corresponding to at least one of the reference mantissa values of each of the distribution graphs by the controller according to the approximation function comprises:
obtaining a first intercept point and a second intercept point of at least one line segment from each of the distribution graphs by the controller; and
computing the first intercept point and the second intercept point by the controller according to the approximation function to respectively generate a first coefficient and a second coefficient,
wherein the step of creating each of the lookup tables by the controller according to the reference mantissa values and the corresponding coefficient comprises:
obtaining a coefficient slope value by the controller according to the first coefficient, the second coefficient and the plurality of reference mantissa values corresponding to the first intercept point and the second intercept point; and
recording the reference mantissa values corresponding to the first intercept point and the second intercept point and the coefficient slope value by the controller to create each of the lookup tables.
